(19) United States
(12) Patent Application Publication
(10) Pub. No.: US 2018/0322580 A1
(43) Pub. Date: Nov. 8, 2018

(54) Intelligent Financial Management System

(71) Applicant: Hui-Chi Hsiung, Kaohsiung City (TW)

(72) Inventor: Hui-Chi Hsiung, Kaohsiung City (TW)

(21) Appl. No.: 15/585,870

(22) Filed: May 3, 2017

(51) Int. Cl. G06Q 40/06; G06N 5/02

(52) U.S. Cl. CPC G06Q 40/06; G06N 5/02

(57) ABSTRACT

An intelligent financial management system contains: at least one database server and multiple use interfaces. Each of the at least one database server has a database configured to store financial information inputted from the multiple use interfaces, and the financial information includes income, expenditure, and investment. The intelligent financial management system provides an evaluation report, after executing a program calculation so that user understands current and future expected risk. The system provides an artificial finance planning and a systematic finance planning to the user based on the evaluation report. When the user chooses the artificial finance planning, the system provides financial management staff information to the user so that the user chooses a financial management staff. When the user chooses the systematic finance planning, the system executes the program calculation and furnishes the financial proposal to the user.

### FIELD OF THE INVENTION

The present invention relates to an intelligent financial management system which contains at least one database server having a database configured to store financial information inputted from multiple use interfaces, wherein the system provides an evaluation report to user so that the user chooses and changes financial strategy, and the system furnishes a performance report and legal asset inheritance information to the user within a service period.

### BACKGROUND OF THE INVENTION

Financial management and performance are more and more important for people as economy is developing.

However, people cannot choose suitable financial planning among a variety of investment items and payment tools. A conventional financial management system merely provides specific financial service but cannot make integrated finance planning.

The present invention has arisen to mitigate and/or obviate the afore-described disadvantages.

### SUMMARY OF THE INVENTION

The primary objective of the present invention is to provide an intelligent financial management system which contains at least one database server having a database configured to store financial information inputted from multiple use interfaces.

Further objective of the present invention is to provide an intelligent financial management system which provides an evaluation report to user so that the user chooses and changes financial strategy.

Another objective of the present invention is to provide an intelligent financial management system which furnishes a performance report and legal asset inheritance information to the user within a service period.

To obtain the above objectives, an intelligent financial management system provided by the present invention contains: at least one database server and multiple use interfaces.

Each of the at least one database server has a database configured to store financial information inputted from the multiple use interfaces, and the financial information includes income, expenditure, and investment.

The intelligent financial management system provides an evaluation report, after executing a program calculation so that user understands current and future expected risk.

The system provides an artificial finance planning and a systematic finance planning to the user based on the evaluation report.

When the user chooses the artificial finance planning, the system provides financial management staff information to the user so that the user chooses a financial management staff who furnishes a financial proposal to the user.

When the user chooses the systematic finance planning, the system executes the program calculation and furnishes the financial proposal to the user, and the financial proposal includes at least one investment item proposal and at least one payment tool selection so as to enhance user's financial profit.

The system furnishes a performance report and legal asset inheritance information to the user within a service period.

Each of the multiple use interfaces is the computer or intelligent communication equipment which accesses to internet.

### BRIEF DESCRIPTION OF THE DRAWINGS

FIG. 1 is a schematic view of an intelligent financial management system according to a preferred embodiment of the present invention.

### DETAILED DESCRIPTION OF THE PREFERRED EMBODIMENTS

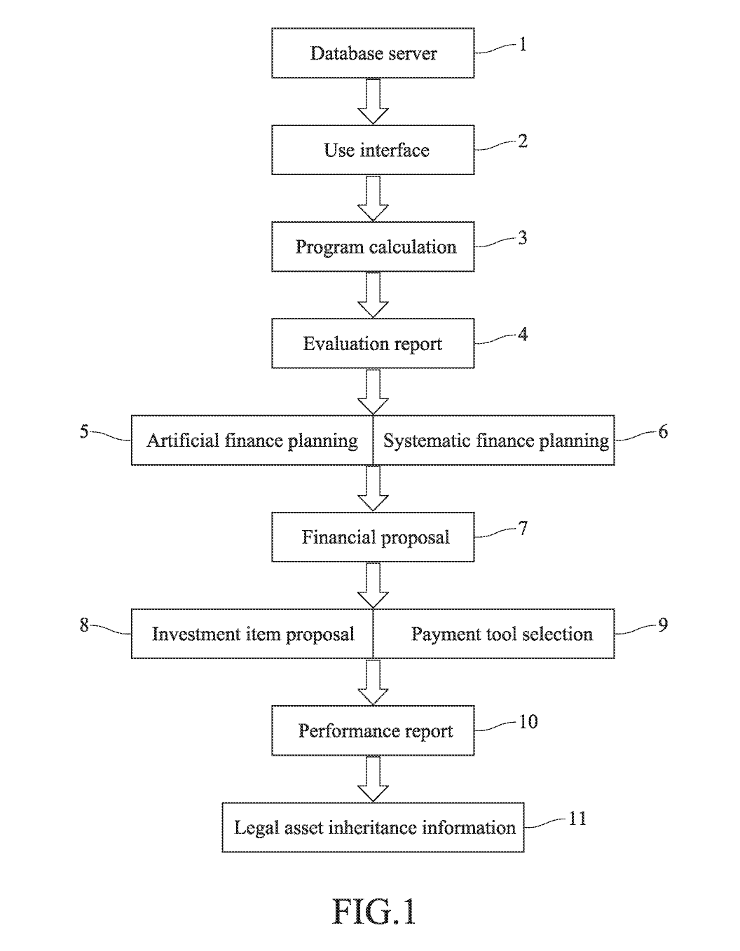

With reference to FIG. 1, an intelligent financial management system according to a preferred embodiment of the present invention comprises: at least one database server 1 and multiple use interfaces 2, wherein each of the at least one database server 1 has a database configured to store financial information inputted from the multiple use interfaces, and the financial information includes income, expenditure, and investment, hence the intelligent financial management system provides an evaluation report 4, after executing a program calculation 3 so that user understands current and future expected risk. Preferably, the system provides an artificial finance planning 5 and a systematic finance planning 6 to the user based on the evaluation report 4. When the user chooses the artificial finance planning 5, the system provides financial management staff information to the user so that the user chooses a financial management staff who furnishes a financial proposal 7 to the user. When the user chooses the systematic finance planning 6, the system executes the program calculation 3 and furnishes the financial proposal 7 to the user. The financial proposal 7 includes at least one investment item proposal 8 and at least one payment tool selection 9 so as to enhance user's financial profit. Preferably, the system furnishes a performance report 10 and legal asset inheritance information 11 to the user within a service period.

The financial information stored in each database server 1 is digital data calculated by a computer. A number of the at least one database server 1 is more than one.

Each of the multiple use interfaces 2 is the computer or intelligent communication equipment which accesses to internet. The input financial information inputted from the multiple use interfaces is instant information from a server (such as a bank) database.

The evaluation report 4 represents by using any one of letters, figures, sounds, and animations, after executing the program calculation 3.

The program calculation 3 calculates the financial information which is stored in each database server 1 and is inputted from the multiple use interfaces 2 by using the computer in which a program is set.

The program calculation 3 uses the financial information which is stored in each database server 1 and is inputted from the multiple use interfaces 2, and the computer changes the program (artificial intelligence) to calculate the financial information according to external economic situation.

When the user chooses the artificial finance planning 5, the financial management staff is recommended to the user by the system.

A number of the at least one investment item proposal 8 is more than one.

A number of the at least one payment tool selection 9 is more than one, and the at least one payment tool selection 9 is any payment system in the market.

The performance report 10 is a result calculated by the program calculation 3, and the result represents by using any one of letters, figures, sounds, and animations in a period time or instantly.

The legal asset inheritance information 11 provides lawful service(s) to the user as making heritage planning.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An intelligent financial management system comprising:
at least one database server and multiple use interfaces;
each of the at least one database server having a database configured to store financial information inputted from the multiple use interfaces, and the financial information including income, expenditure, and investment;
the intelligent financial management system providing an evaluation report, after executing a program calculation so that user understands current and future expected risk;
the system providing an artificial finance planning and a systematic finance planning to the user based on the evaluation report;
wherein when the user chooses the artificial finance planning, the system provides financial management staff information to the user so that the user chooses a financial management staff who furnishes a financial proposal to the user;
wherein when the user chooses the systematic finance planning, the system executes the program calculation and furnishes the financial proposal to the user, and the financial proposal includes at least one investment item proposal and at least one payment tool selection so as to enhance user's financial profit; and
wherein the system furnishes a performance report and legal asset inheritance information to the user within a service period.

2. The system as claimed in claim 1, wherein the financial information stored in each database server is digital data calculated by a computer.

3. The system as claimed in claim 1, wherein a number of the at least one database server is more than one.

4. The system as claimed in claim 1, wherein each of the multiple use interfaces is the computer or intelligent communication equipment which accesses to internet.

5. The system as claimed in claim 1, wherein the input financial information inputted from the multiple use interfaces is instant information from a server database, and the server database is a bank database.

6. The system as claimed in claim 1, wherein the evaluation report represents by using any one of letters, figures, sounds, and animations, after executing the program calculation.

7. The system as claimed in claim 1, wherein the program calculation calculates the financial information which is stored in each database server and is inputted from the multiple use interfaces by using the computer in which a program is set.

8. The system as claimed in claim 1, wherein the program calculation uses the financial information which is stored in each database server and is inputted from the multiple use interfaces, and the computer changes the program (artificial intelligence) to calculate the financial information according to external economic situation.

9. The system as claimed in claim 1, wherein when the user chooses the artificial finance planning, the financial management staff is recommended to the user by the system.

10. The system as claimed in claim 1, wherein a number of the at least one investment item proposal is more than one.

11. The system as claimed in claim 1, wherein a number of the at east one payment tool selection is more than one.

12. The system as claimed in claim 1, wherein the at least one payment tool selection is any payment system in the market.

13. The system as claimed in claim 1, wherein the performance report is a result calculated by the program calculation, and the result represents by using any one of letters, figures, sounds, and animations in a period time or instantly.

14. The system as claimed in claim 1, wherein the legal asset inheritance information provides lawful service(s) to the user as making heritage planning.
